(19) United States
(12) Patent Application Publication
(10) Pub. No.: US 2025/0044783 A1
(43) Pub. Date: Feb. 6, 2025

(54) METHOD, DEVICE, MEDIUM AND PRODUCT FOR STATE PREDICTION OF A PHYSICAL SYSTEM

(71) Applicant: Lemon Inc., Grand Cayman (KY)

(72) Inventors: Weihao GAO, Beijing (CN); Ce YANG, Beijing (CN); Di WU, Beijing (CN); Chong WANG, Los Angeles, CA (US)

(21) Appl. No.: 18/713,988

(22) PCT Filed: Nov. 7, 2022
(86) PCT No.: PCT/SG2022/050807

§ 371 Date: May 28, 2024

(30) Foreign Application Priority Data
Nov. 26, 2021 (CN) 202111422063.2

(51) Int. Cl. G05B 23/02

(52) U.S. Cl. CPC G05B 23/0281

(57) ABSTRACT

According to embodiments of the present disclosure, there are provided a method, device, medium, and product for state prediction. The method includes: obtaining a neural network, the neural network being trained to determine a state change of a physical system over time, training data of the neural network indicating states of a plurality of physical systems at a plurality of times; obtaining state data corresponding to a state of a target physical system at a first time; determining respective unit feature representations of the physical units in the target physical system based at least on target values of material properties of the physical units; and determining a state of the target physical system at a second time based on the state data by inputting at least the unit feature representations to the neural network. Through the above solution, generalization capability of the neural network can be significantly improved.

This application claims priority to Chinese Application No. 202111422063.2, entitled “method, device, medium and product for state prediction of a physical system” and filed on Nov. 26, 2021.

### FIELD

Example embodiments of the present disclosure generally relate to the field of artificial intelligence (AI), and in particular to, a method, device, medium, and product for state prediction of a physical system.

### BACKGROUND

The dynamics of physical systems studies how states of a physical system change due to the action of forces. Dynamics modeling of physical systems is of great importance to the development of science and engineering. For example, in scientific and engineering research, it may be desirable to simulate the motion of a sand pile, the deformation of a snow block after collision and compression, the deformation of an elastomer during a fall, or the finite element mechanical (FEM) analysis of an elastomer on an irregular obstacle, etc.

The construction of high-precision physics simulators requires extensive domain knowledge and a significant amount of engineering work. However, the approximation techniques used to ensure perceptual realism make such simulations deviate from the true pattern in the long run. With the continuous evolution of machine learning technology, neural network-based physics simulators (also referred to as “physics engines”) have been proposed to learn dynamics a state change of physical systems over time from a large amount of training data. Studies have demonstrated the feasibility of machine learning technology in improving dynamics modeling of physical systems.

### SUMMARY

According to example embodiments of the present disclosure, there is provided a solution for state prediction of a physical system.

In a first aspect of the present disclosure, there is provided a method for state prediction. The method comprises: obtaining a neural network, the neural network being trained to determine a state change of a physical system over time, training data of the neural network indicating states of a plurality of physical systems at a plurality of times; obtaining state data corresponding to a state of a target physical system at a first time, the state data indicating a plurality of physical units comprised in the target physical system, material properties of the plurality of physical units, and interaction relationships between the plurality of physical units; determining respective unit feature representations of the plurality of physical units in the target physical system based at least on target values of respective material properties of the plurality of physical units; and determining a state of the target physical system at a second time based on the state data by inputting at least the unit feature representations to the neural network.

In a second aspect of the present disclosure, there is provided an electronic device. The device comprises at least one processing unit; and at least one memory coupled to the at least one processing unit and storing instructions for execution by the at least one processing unit, the instructions, when executed by the at least one processing unit, causing the device to perform the following actions: obtaining a neural network, the neural network being trained to determine a state change of a physical system over time, training data of the neural network indicating states of a plurality of physical systems at a plurality of times; obtaining state data corresponding to a state of a target physical system at a first time, the state data indicating a plurality of physical units comprised in the target physical system, material properties of the plurality of physical units, and interaction relationships between the plurality of physical units; determining respective unit feature representations of the plurality of physical units in the target physical system based at least on target values of respective material properties of the plurality of physical units; and determining a state of the target physical system at a second time based on the state data by inputting at least the unit feature representations to the neural network.

In a third aspect of the present disclosure, there is provided an apparatus for state prediction. The apparatus comprises a network obtaining unit configured to obtain a neural network, the neural network being trained to determine a state change of a physical system over time, training data of the neural network indicating states of a plurality of physical systems at a plurality of times; a state obtaining unit configured to obtain state data corresponding to a state of a target physical system at a first time, the state data indicating a plurality of physical units comprised in the target physical system, material properties of the plurality of physical units, and interaction relationships between the plurality of physical units; a feature representation determining unit configured to determine respective unit feature representations of the plurality of physical units in the target physical system based at least on target values of respective material properties of the plurality of physical units; and a state determining unit configured to determine a state of the target physical system at a second time based on the state data by inputting at least the unit feature representations to the neural network.

In a fourth aspect of the present disclosure, there is provided a computer-readable storage medium. The medium has a computer program stored thereon, the computer program, when executed by a processing unit, performing the method according to the first aspect.

In a fifth aspect of the present disclosure, there is provided a computer-readable storage medium. The medium has a computer program stored thereon, the computer program, when executed by a processing unit, performing the method according to the first aspect.

In a sixth aspect of the present disclosure, there is provided a computer program product. The computer program product includes a computer program executable by a processing unit, the computer program comprising instructions for performing the method according to the first aspect.

It would be appreciated that the content described in the section is neither intended to identify the key features or essential features of the present disclosure, nor is it intended to limit the scope of the present disclosure. Other features of the present disclosure will be readily understood through the following description.

### BRIEF DESCRIPTION OF THE DRAWINGS

The above and other features, advantages and aspects of various embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a flowchart of a process for state prediction of a physical system according to some embodiments of the present disclosure;

FIG. 3 illustrates a block diagram of an example structure of a network application system according to some embodiments of the present disclosure;

FIG. 4 illustrates an example algorithm for running a neural network according to some embodiments of the present disclosure;

FIG. 5 illustrates an example directed graph for modeling a physical system according to some embodiments of the present disclosure;

FIG. 6 illustrates a block diagram of an apparatus for state prediction of a physical system according to some embodiments of the present disclosure; and

FIG. 7 illustrates a block diagram of a computing device in which one or more embodiments of the present disclosure may be implemented.

### DETAILED DESCRIPTION

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

In the description of the embodiments of the present disclosure, the term “comprising”, and similar terms would be appreciated as open inclusion, that is, “comprising but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

As used herein, the term “model” can learn an association between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

A “neural network” is a machine learning network based on deep learning. A neural network is capable of processing inputs and providing corresponding outputs, and typically includes an input layer and an output layer and one or more hidden layers between the input layer and the output layer. Neural networks used in deep learning applications often include many hidden layers, thereby increasing the depth of the network. The layers of a neural network are connected in sequence such that the output of the previous layer is provided as the input of the subsequent layer, where the input layer receives the input of the neural network and the output of the output layer serves as the final output of the neural network. Each layer of a neural network consists of one or more nodes (also called processing nodes or neurons), each of which processes input from the previous layer.

Generally, machine learning may generally involve three stages, i.e., a training stage, a test stage, and an application stage (also referred to as an inference stage). At the training stage, a given machine learning model may be trained using a large scale of training data to iteratively update parameter values, until the model can obtain, from the training data, consistent inference that satisfies an expected goal. Through the training process, the machine learning model may be regarded as being capable of learning the association between the input and the output (also referred to an input-output mapping) from the training data. At the test stage, a test input is applied to the trained machine learning model to test whether the model can provide an accurate output, to determine the performance of the model. At the application stage, the model may be used to process a real-world model input based on the trained parameter values and to determine a corresponding output.

As mentioned above, the dynamics of physical systems may be modeled by training neural networks with machine learning technology, so as to predict the dynamics state of physical systems.

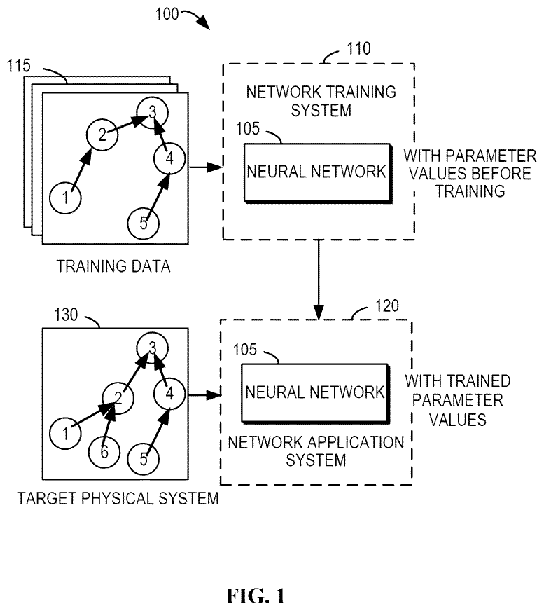

FIG. 1 illustrates a block diagram of an environment 100 in which various implementations of the present disclosure may be implemented. In the environment 100 of FIG. 1, it is desired to train and use such a neural network 105 for determining changes in the state of a physical system over time. Such the neural network 105 may sometimes be referred to as a physics engine, a neural network-based physics engine, a physics simulator, etc.

A physical system can usually be divided into a plurality of physical units with interaction relationships therebetween which may be caused by the forces on the plurality of physical units. The study of physical dynamics typically focuses on how locations of the plurality of physical units in the physical system change with time under the action of external forces. The plurality of physical units in the physical system and their interaction relationships at each time constitute the state of the physical system at that time.

For example, different physical systems correspond to various types of amorphous bodies such as fluids, solids, gases, liquids, sand piles, snow, etc., or to different types of shaped bodies such as various elastomers, rigid bodies, etc. Physical units in a physical system can be composed of corresponding types of materials, and different materials have different material properties. In some cases, a physical system can be composed of multiple materials, so that different physical units might have different material properties.

It is desirable to effectively simulate the physical dynamics of different physical systems in various scenarios by training neural networks.

The environment 100 includes a network training system 110 and a network application system 120. In the example embodiment of FIG. 1 and some example embodiments to be described below, the network training system 110 is configured to train a neural network 105 using training data 115, so as to optimize the parameter values of the neural network 105 and thus to obtain trained parameter values. The neural network 105 is configured to be adapted for predicting a state of the physical system at a second time based on a state of the physical system at a first time. Such a neural network 105 may be referred to as a physics engine, or physics simulator.

As described above, a physical system can be regarded as composed of a plurality of physical units, and there are interaction relationships between the plurality of physical units. Therefore, physical systems can be characterized by graph data, especially directed graphs. A directed graph consists of a plurality of nodes and directed edges connecting the plurality of nodes. These edges can have directions to indicate the direction of interaction between the physical units corresponding to the connected nodes. When characterizing a physical system, the granularity of physical units can be divided as needed. For example, for a fluid system, the physical unit may include particles; for example, in a system corresponding to water, the physical unit may include water droplets. For a system corresponding to sand, the physical unit may include sand grains. For an elastomer system, the physical unit can include meshes in the elastomer.

The trajectory of the dynamics state change of the physical system can be represented as (G⁰, G¹, . . . , G^{T}), where the directed graph G^{t}=<O^{t}, R^{t}>∈ [symbol] represents the state of the physical system at time t (t=0, 1, . . . , T). Hereinafter, the symbol t representing time is omitted where no ambiguity is caused. O={oᵢ^{ξ}} represents a set of nodes in the directed graph, each node Oᵢ^{ξ} corresponds to a physical unit, and ξ represents the material property of the physical unit. R={(oᵢ^{ξ}, oⱼ^{η})} represents an interaction relationship between the physical units corresponding to the connected nodes, i.e., (oᵢ^{ξ}, oⱼ^{η})∈R means that there is an interaction relationship between the physical unit with the material property ξ corresponding to the node Oᵢ^{ξ} and the physical unit with the material property η corresponding to the node Oⱼ^{η}.

When training the neural network 105, the training data 115 includes state data indicative of states of each of a plurality of physical systems at a plurality of times. The state of a physical system at a time can be characterized by a directed graph. For example, as schematically shown in FIG. 1, the training data 115 may include a directed graph of the state of a physical system at a certain time, including a plurality of physical units 1-6. Some pairs of physical units in these physical units are connected by directed edges to indicate that these physical units have an interaction relationship between them. The training data 115 may further include a state of the same physical system at the next one or more times to form a trajectory of a state change, such as (G⁰, G¹, . . . , G^{T}). In some examples, the training data 115 may indicate changes in the state of the same physical system over time under the action of external forces.

The plurality of physical systems involved in the training data 115 may have physical systems with the same material properties. For example, these physical systems are all for fluids with specific materials (for example, liquid, sand, snow, etc.), elastomers for specific materials, a certain physical system for finite element analysis, and so on.

The neural network 105 may be configured as any neural network suitable for processing graph data, such as a graph neural network (GNN). Before training, parameter values of the neural network 105 may be initialized, or pre-trained parameter values may be obtained through a pre-training process. The parameter values of the neural network 105 are updated and adjusted through the training process of the network training system 110. After training is completed, the neural network 105 has trained parameter values. Based on such parameter values, the neural network 105 can be used for state prediction of the physical system.

In FIG. 1, the network application system 120 receives state data 130 that represents the state of a target physical system at a certain time. The target physical system includes a plurality of physical units, and there are interactive relationships between the plurality of physical units. The material properties of each physical unit can be the same or different. The network application system 120 may be configured to determine the state of the target physical system at a subsequent time using the trained neural network 105. The target physical system may be dynamically similar to the physical system used to train the neural network 105, such as containing physical units with the same material properties. However, as will be discussed below, the values of these material properties may be the same or different.

In FIG. 1, the network training system 110 and the network application system 120 can be any systems with computing capabilities, such as various computing devices/systems, terminal devices, servers, etc. The terminal device may be any type of mobile terminal, fixed terminal or portable terminal, including a mobile phone, a desktop computer, a laptop computer, a notebook computer, a tablet computer, a media computer, a multimedia tablet, or any combination thereof, including accessories and peripherals for these devices or any combination thereof. The server includes, without limitation to, a mainframe, an edge computing node, a computing device in a cloud environment, and so on.

It should be understood that the components and arrangements in the environment illustrated in FIG. 1 are examples only, and that the computing system suitable for implementing the example embodiments described herein may include one or more different components, other components, and/or different arrangements. For example, the network training system 110 and the network application system 120, though shown as separate, may be integrated in the same system or device. Embodiments of the present disclosure are not limited in this regard.

When implementing simulations of the dynamics of simulations of physical systems based on machine learning, machine learning relies on training data. Therefore, existing solutions often lack generalization to unknown physical processes and substances. For example, if the training data involves a physical system that includes softer elastic materials and stiffer elastic materials, the trained neural network (i.e., the physics engine) cannot be used to prepare predictions about the dynamics states of elastic materials with other elasticity levels. In other words, machine learning-based simulators can only simulate physical systems that have been seen in the training data, but not those unseen. Considering the needs of practical applications, it is expected that the trained physics engine can be generalized to unseen physical systems.

According to embodiments of the present disclosure, an improved solution for state prediction of a physical system is proposed. According to this solution, feature representations related to material properties are introduced in the input of neural networks used to simulate physical systems. The material properties can be, for example, a viscosity of a fluid, an inclination angle of sand, Young's modulus of an elastomer, etc. With this solution, neural networks trained on physical systems with multiple different values of material properties can be generalized for state prediction of physical systems with otherwise unseen material property values.

With the above solution, the generalization capability of the neural network can be significantly improved, so that the trained neural network can maintain high prediction accuracy for unseen material property values.

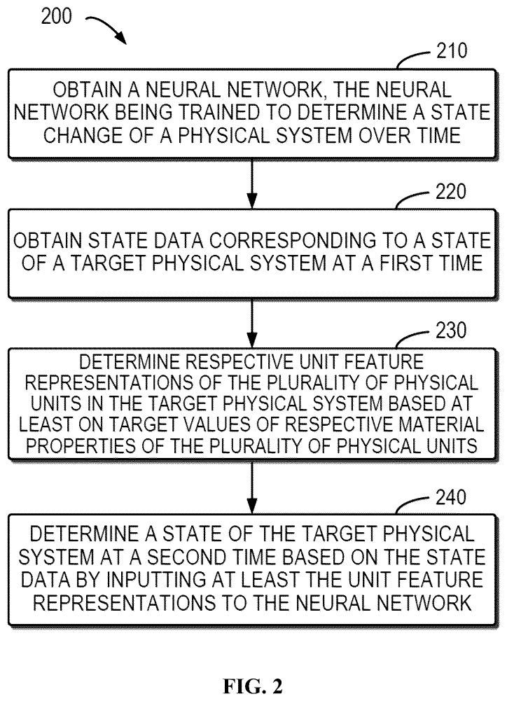

FIG. 2 illustrates a flowchart of a process 200 for state prediction of a physical system according to some embodiments of the present disclosure. The process 200 may be implemented at the network application system 120 of FIG. 1.

At block 210, the network application system 120 obtains the neural network 105 which is trained to determine a state change of a physical system over time. The neural network 105 obtained by the network application system 120 may have been trained by the network training system 110 using the training data 115.

The neural network 105 can be trained to simulate dynamics of a physical system. Physical units with different material properties can have different dynamics behaviors. As mentioned above, the physical units in the plurality of physical systems involved in the training data 115 may have corresponding material properties.

For example, for a fluid, the material property may include the viscosity of the fluid; for a sand pile, the material property may include the inclination angle of the sand pile; for snow, the material property may include the hardening coefficient of the snow; for a particle elastomer, the material property may include the hardness of the elastomer; for a physical system used for FEM analysis, such as for analyzing the collision deformation of an elastomer on an irregular obstacle, the material property can include the Young's modulus of the elastomer.

In a same physical system, the physical units therein can have either the same or different material properties. In a plurality of physical systems involved in the training data 115, for physical units with the same material property, their values may be different, for example, may have at least two different values. For example, one or more physical systems in the training data 115 include a first viscosity value of a fluid physical unit, and one or more other physical systems include a second viscosity value of the fluid physical unit.

In the application of the neural network 105, the network system 120 predicts the dynamics state of the target physical system over time. Specifically, at block 220, the network application system 120 obtains state data 130 corresponding to a state of a target physical system at a time. The network application system 120 can apply the neural network 105 to predict a state of the target physical system at a subsequent time.

The state data 130 indicates a plurality of physical units included in the target physical system, material properties of the plurality of physical units, and interaction relationships between the plurality of physical units. For example, the state data may include a directed graph G^{t}=<O^{t}, R^{t}>∈ [symbol] indicating the state of the physical system at time t(t=0, 1, . . . , T), where O={oᵢ^{ξ}} represents a set of nodes in the directed graph, each node Oᵢ^{ξ} corresponds to a physical unit, ξ represents the material property of the physical unit; R={(oᵢ^{ξ}, oⱼ^{η})} represents the interaction relationship between the physical units corresponding to the connected nodes, that is, (oᵢ^{ξ}, oⱼ^{η})∈R means that there is an interaction relationship between the physical unit with the material property ξ corresponding to the node Oᵢ^{ξ} and the physical unit with the material property η corresponding to the node oⱼ^{η}.

In some embodiments, where the state of the physical system is represented by graph data, the neural network 105 may include a graph neural network, thus also referred to as a graph-based physics engine (GPE). The neural network 105 can be implemented in various types of machine learning architectures, such as multi-layer perception (MLP) neural networks, etc.

In some embodiments, the neural network 105 can be configured to determine the location of each physical unit in the physical system at the next time based on the current state of the physical system. Based on the location changes of each physical unit, the state of the physical system at the next time can be determined.

In some embodiments, since the physical units have force interactions with each other, the neural network 105 is configured to determine the location change of the physical unit from the current location to the next time by determining the influence passed from one physical unit to another. In such an implementation, the neural network 105 may implement state prediction based on a message passing neural network (MPNN) architecture.

Generally, the neural network 105, since trained using training data, can learn how to simulate the physical system for each value of the material property contained in the training data 115. As mentioned above, in the traditional solutions, the trained neural network can only be applied to simulate physical systems with values of material properties that have appeared in the training data. Therefore, the generalization capability of the neural network is poor, and the use of the network is rather limited.

In embodiments of the present disclosure, to enable the trained neural network 105 to be generalized for predicting physical systems with unseen material property values, a feature representation related to a material property is introduced into the input feature of the neural network 105. In this specification, the “feature representation” is used to characterize the properties of an object (in this example, a material property with a specific value) in the form of a multidimensional vector, including multiple vector elements. The feature representation is sometimes referred to as a vector representation or embedding.

By introducing feature representations related to material properties in the input features, during model training, the feature representations related to material properties in the input features can be optimized to accurately characterize the material property values that have appeared in the training data.

Specifically, when performing state prediction on the target physical system, at block 230, the network application system 120 determines respective unit feature representations of the plurality of physical units of the target physical system based at least on target values of respective material properties of the plurality of physical units of the target physical system. Depending on the material properties of the individual units and the values of the material properties, the unit feature representation for each physical unit can be varied.

At block 240, the network application system 120 determines a state of the target physical system at a second time based on the state data by inputting at least the unit feature representation to the neural network 105.

As will be mentioned below, in addition to the respective unit feature representations of the physical units, the input of the neural network 105 may also include respective relationship feature representations of the interaction relationships between the plurality of physical units. The neural network 105 determines the state of the target physical system at the second time using these physical units, the material properties of the physical units and the interaction relationships between the physical units as indicated by the state data.

According to embodiments of the present disclosure, by continuously introducing values of material properties into input features, the neural network 105 can be utilized to predict a state change over time of a target physical system having material property values that is not seen at training time. In this way, the generalization capability of the trained neural network is improved, and the physical environment that can be used for prediction is expanded.

In some embodiments, as will be described in detail below, the internal processing of the neural network 105 can also be improved by introducing constraints on the law of momentum conservation, to increase the stability of neural network training and long-term running stability.

In addition, in some embodiments, different discretized physical systems can be characterized by different graph topologies, and state prediction can be implemented using a unified architecture of neural networks.

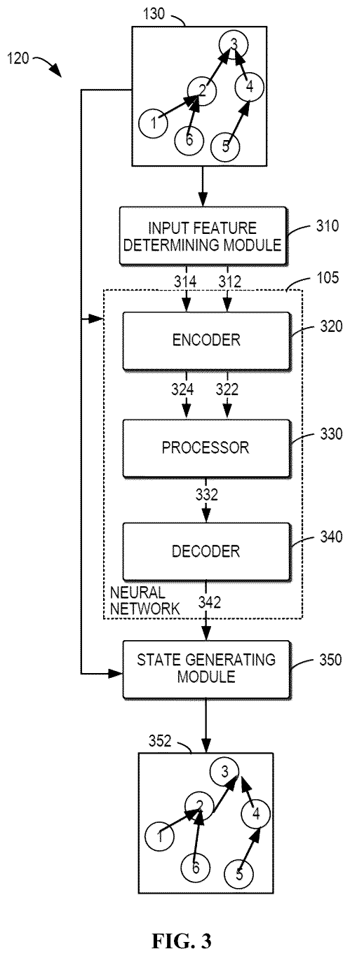

Some embodiments of the present disclosure have been generally described above. For a better understanding, the example processing flow of the neural network 105 will be described with reference to FIG. 3. This figure illustrates a block diagram of an example structure of the network application system 120 according to some embodiments of the present disclosure. Each module/component in the network application system 120 can be implemented by hardware, software, firmware, or any combination thereof. The network application system 120 is used to train the neural network 105 to implement state prediction of the physical system.

In the example of FIG. 3, the neural network 105 implements state prediction based on MPNN. As shown in FIG. 3, neural network 105 may include an encoder 320, a processor 330, and a decoder 340. The network application system 120 includes an input feature determining module 210 configured for determining an input feature to be input to the neural network 105 for a target physical system to be predicted.

The network application system 120 can obtain state data 130 corresponding to the status of the target physical system at a first time. The input feature determining module 210 may determine, from the state data 130, physical units included in the target physical system, material properties of the plurality of physical units, and interaction relationships between the plurality of physical units. The input feature determining module 210 may also determine target values for material properties of the plurality of physical units from additional information associated with the target physical system.

As mentioned above, the input feature determining module 210 determines respective unit feature representations 312 for the plurality of physical units of the target physical system based at least on the target values of respective material properties of the plurality of physical units. In some embodiments, the input feature determining module 210 may also determine respective relationship feature representations 314 for interaction relationships between the plurality of physical units. The process for determining the unit feature representation 312 and the relationship feature representation 314 will be described in detail below. The unit feature representation 312 and the relationship feature representation 314 are used as inputs to the neural network 105.

In the neural network 105, the unit feature representation 312 and the relationship feature representation 314 are input into the neural network 105 as original feature representations of the physical unit and the interaction relationship between the physical units respectively. In some embodiments, the neural network 105 treats physical units with different material properties as different types of physical units, thereby applying processing operations specific to the material properties.

Specifically, the encoder 320 in the neural network 105 processes the input original feature representations to map these feature representations to a latent vector space. The encoder 320 may encode, for each physical unit and the interaction relationship between each pair of physical units, to obtain an intermediate encoded representation 322 corresponding to each unit feature representation 312 and an intermediate encoded representation 324 corresponding to each relationship feature representation 314.

In some embodiments, when encoding a unit feature representation 312, the encoder 320 can utilize an encoding processing approach corresponding to material properties of a physical unit corresponding to the unit feature representation 312. In some embodiments, for a relationship feature representation 314, the encoder 320 can utilize an encoding processing approach corresponding to material properties of a pair of physical units corresponding to the relational feature representation 314.

The processing of the encoder 320 can be represented as:

$${h}_{i}^{ξ , 0} = {f}_{v , 0}^{ξ} ( features ( {o}_{i}^{ξ} ) ) , for all nodes {o}_{i}^{ξ} ∈ O \qquad Equation 1$$

$${h}_{i , j}^{0} = {f}_{e , 0}^{( ξ , η )} ( features ( {o}_{i}^{ξ} , {o}_{j}^{η} ) ) , for all edges ( {o}_{i}^{ξ} , {o}_{j}^{η} ) ∈ R$$

In Equation (1), oᵢ^{ξ}∈O represents the ith node in the node set O in the directed graph used to characterize the state of the target physical system at the first time, ξ represents the material property of the ith physical unit corresponding to the node, features (oᵢ^{ξ}) represents the unit feature representation 312 of the ith physical unit, f_{v, 0}^{ξ} ( ) represents the encoding processing approach of the relationship feature representation used by the encoder 320 for the material attribute ξ, and hᵢ^{ξ, 0} represents the intermediate feature representation 322 extracted by the encoder 320 for the ith node.

In Equation (1), (oᵢ^{ξ}, oⱼ^{η})∈R represents an interaction relationship between the physical unit with the material property ξ corresponding to the node oᵢ^{ξ} and the physical unit with the material property η corresponding to the node oⱼ^{η} in the directed graph, features (oᵢ^{ξ}, oⱼ^{η}) represents the relationship feature representation 314 of the interaction relationship, f_{e, 0}^{(ξ, η)} ( ) represents the encoding processing approach of the relationship feature representation used by the encoder 320 for the material property ξ and material property η; h_{i,j}^{( )} represents the intermediate feature representation 324 extracted by the encoder 320 for edges (oᵢ^{ξ}, oⱼ^{η})∈R.

The intermediate feature representation 322 and intermediate feature representation 324 are provided to the processor 330. Then, the processor 330 continues to explore the features of each physical unit of the target physical system in the state at the first time, so as to predict the location of each physical unit at the next time.

Specifically, in the MPNN-based architecture, the processor 330 may determine message passing from a source physical unit to a destination physical unit based on the intermediate feature representation 322 corresponding to the physical unit and the intermediate feature representation 324 corresponding to the interaction relationship between the physical units, so as to generate a message feature representation from the source physical unit to the destination. The message feature representation is determined based on the unit feature representation corresponding to the source physical unit, the unit feature representation of the destination physical unit, and the relationship feature representation of the interaction relationship between the two physical units, and more specifically, the intermediate feature representations obtained based on the encoding of these feature representations. The message feature representation from the source physical unit to the destination may characterize the effect of the source physical unit on the destination physical unit, for example, in the case of an applied force, may at least indicate the effect of the force from the source physical unit to the destination physical unit.

In some embodiments, the processor 330 may determine the message feature representation from one physical unit to another physical unit through multiple iterations, so that the effect of multiple neighboring nodes of one physical unit can be characterized into the message feature representation. The message feature representation processor 330 may determine a final feature representation 342 for each physical unit based on the message feature representation, for use in predicting the location of the physical unit at the next time.

The processing of the processor 330 may be represented as follows, in which the following processing is iteratively performed for L rounds, and in the lth round of processing (l=1, . . . L, where L can be a preconfigured value):

$${m}_{i , j}^{l} = {f}_{e , l}^{( ξ , η )} ( {h}_{i}^{ξ , l - 1} , {h}_{j}^{η , l - 1} , {h}_{i , j}^{l - 1} ) , for all edges ( {o}_{i}^{ξ} , {o}_{j}^{η} ) ∈ R \qquad ( 2 )$$

$${m}_{j , i}^{l} = - {m}_{i , j}^{l} , for all edges ( {o}_{i}^{ξ} , {o}_{j}^{η} ) ∈ R$$

$${h}_{i}^{ξ , l} = {h}_{i}^{ξ , l - 1} + {f}_{v , l}^{ξ} ( {\sum }_{j ∈ {𝒩}_{i}} {m}_{i , j}^{l} ) , for all nodes {o}_{i}^{ξ} ∈ O$$

$${h}_{ij}^{l} = {h}_{i , j}^{l - 1} + {m}_{i , j}^{l} for all ( {o}_{i}^{ξ} , {o}_{j}^{η} ) , for all edges ( {o}_{i}^{ξ} , {o}_{j}^{η} ) ∈ R$$

In Equation (2), m_{i,j}^{l} means determining a message feature representation from the ith physical unit corresponding to the ith node oᵢ^{ξ} to the jth physical unit corresponding to the jth node oⱼ^{η} in the lth round of processing, f_{e, l}^{(ξ, η)} ( ) and represents the processing approach used by the processor 330 for the material properties ξ and η. hᵢ^{ξ, l} represents the intermediate feature representation extracted by the processor 330 for the ith node in the lth round of processing, which is determined based on an aggregation result of the message feature representation from the adjacent physical unit to the ith physical unit and the intermediate feature representation hᵢ^{ξ, l-1} of the node; the aggregation processing of the message feature representation f_{v, l}^{ξ} ( ) is specific to the material properties of the ith physical unit; [symbol] represents the node set corresponding to the adjacent physical units of the ith physical unit. h_{i,j}^{l} represents the intermediate feature representation extracted by the processor 330 on the edges (oᵢ^{ξ}, oⱼ^{η})∈R in the lth round of processing, which is based on the sum of the intermediate feature representations m_{i,j}^{l} of the edge in the previous round of processing.

After L rounds, the final feature representation 342 hᵢ^{ξ, L} obtained for each physical unit is provided to the decoder 340. The decoder 340 predicts a location 252 of each physical unit at the next time (i.e., the second time) from the final feature representation 342 hᵢ^{ξ, L} of the physical unit, which can be represented as:

$${a}_{i}^{ξ} = {f}_{v}^{ξ} ( {h}_{i}^{ξ , L} ) , for all nodes {o}_{i}^{ξ} ∈ O \qquad ( 3 )$$

In Equation (3), fᵥ^{ξ} ( ) represents the decoding processing approach used by the decoder 340 for the material properties ξ of the ith physical unit, and aᵢ^{ξ} represents the location of the ith physical unit at the second time.

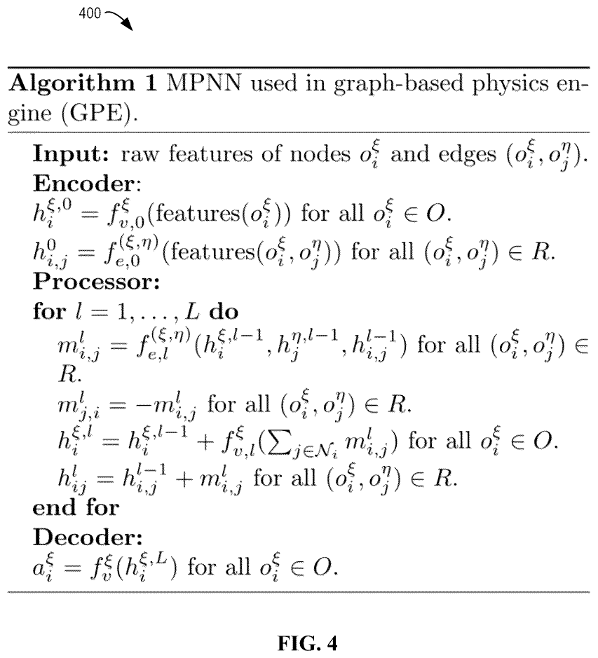

FIG. 4 illustrates an example algorithm 400 for running the neural network 105 in the embodiments described above.

The predicted location 342 of each physical node in the target physical system at the second time is provided to a state determining module 350 in the network application system 120. The state determining module 350 may generate, based on the state of the target physical system at the first time and by utilizing the predicted location of each physical unit at the second time, state data 352 characterizing the state of the target physical system at the second time, for example, graph data characterizing the state.

It would be appreciated that in the neural network 105, the various material property-specific processing approaches used by the encoder 220, the processor 230 and the decoder 340 in the foregoing description can be represented by processing functions, and the parameter values used by these processing functions are determined during the training process of the neural network 105.

In the present disclosure, by introducing feature representations related to material properties in the input features, the trained neural network 105 can be used to predict more physical systems under the same material properties.

When determining the feature representation of each physical unit in the target physical system, the input feature determining module 310 may learn about the material properties and their values of each physical unit in the plurality of physical systems involved in the training data 115. The input feature determining module 310 determines whether the target value of the material property of the physical unit is the same as the value of the material property of the physical unit in the physical system used to train the neural network 105.

For known values in the material property, there may exist feature representations corresponding to these values. These feature representations have been included in the neural network's input features during the training stage of the neural network 105. In some embodiments, if the same value of the same material property can be found, the input feature determining module 310 can directly use the feature representation corresponding to the known value of the material property as at least part of the unit feature representation 312 of the physical unit of the target network system.

In some cases, for certain physical units in the target physical system, if the target value of the material property of the physical unit is different from the value of the physical unit with the same material property in the training data 115, the input feature determining module 310 may determine whether or not the target value for the material property of the physical unit falls between two known values (sometimes referred to as first value and second value). If yes, the input feature determining module 310 may determine the unit feature representation 312 of the physical unit in the target physical system based at least on the first feature representation corresponding to the first value and the second feature representation corresponding to the second value of the material property.

Specifically, feature representations of values of the same material property can be considered to conform to a continuous distribution. The input feature determining module 310 may determine the target value corresponding to the material property of that physical unit in the target physical system from the first feature representation corresponding to the first value and the second feature representation corresponding to the second value by using an interpolation operation, which may be represented as follows:

$$Θ ( λ {v}_{1} + ( 1 - λ ) {v}_{2} ) = λΘ ( {v}_{1} ) + ( 1 - λ ) Θ ( {v}_{2} ) \qquad ( 4 )$$

where v1 represents the first value of a certain material property, v2 represents the second value of the same material property; Θ(v₁) and Θ(v2) represent the first feature representation corresponding to the first value and the second feature representation corresponding to the second value, respectively; Θ(λv₁+(1−λ)v₂) represents the feature representation corresponding to another value (which is between v1 and v2) of the same material property.

In the example of Equation (4), the interpolation of the first feature representation and the second feature representation is performed using a continuous interpolation operation. The respective interpolation weights λ and (1−λ) of the first feature representation and the second feature representation may be calculated based on a difference between the target value of the material property possessed by the physical unit in the target physical system and the first value and the second value. For example, if the difference between the target value and the first value is smaller, then λ is determined to be a greater value, and accordingly, (1−λ) is determined to be a smaller value.

Through such an interpolation operation, for any target physical system, the neural network 105 can be utilized to perform accurate state predictions, as long as the material properties of its physical units are the same as those involved in the training data used to train the neural network 105, and the values of the material properties fall into values seen by the neural network 105 from the training data.

In some embodiments, for a physical unit, in addition to the material property, the unit feature representation 312 may further indicate other aspects of information. For example, the input feature determining module 310 may further determine the unit feature representation 312 of each physical unit based on the velocity of the physical unit at the first time and/or the external force applied to the physical unit at the first time. The velocity and/or external force may each be mapped to respective feature representations, which are concatenated with feature representations determined for the material property to form the unit feature representation 312 of the physical unit.

It can be understood that the unit feature representation 312 of a physical unit may also be determined based on other information associated with the physical unit. Embodiments of the present disclosure are not limited in this regard.

In some embodiments, when determining the relationship feature representation 314, the input feature determining module 310 may determine the relationship feature representation 314 of the interaction relationship between a pair of physical units having the interaction relationship based on the relative locations of the pair of physical units at the first time. Such a relationship feature representation 314 can characterize the relative positioning relationship between a pair of physical units. The state data 130 may specifically indicate the location of each physical unit at the first time. In some embodiments, the relationship feature representation 314 may not characterize the location of each physical unit in a pair of physical units. This allows the trained neural network 105 to naturally satisfy translation invariance.

In some embodiments of the present disclosure, as mentioned above, the law of momentum conservation may also be introduced into the internal processing in the neural network 105. Specifically, the law of momentum conservation can be used to constrain the determined message feature representation when determining message passing between two physical units. After determining the message feature representation from one physical unit to another physical unit, the processor 330 in the neural network 105 may directly determine the negative value of the message feature representation as the message feature representation from another physical unit to the previous physical unit. This is indicated in the above Equation (3) as the processing of m_{j, i}^{l}=m_{i,j}^{l}, that is, the message feature representation m_{j, i}^{l} from the jth physical unit to the ith physical unit is the negative of the message feature representation m_{i,j}^{l} from the ith physical unit to the jth physical unit. The message feature representation from a source physical unit to a destination physical unit indicates the effect of the source physical unit on the destination physical unit. In the dynamics of the physical system, such effect reflects the action of forces. Therefore, it can be indicated from the calculation of m_{j, i}^{l}=m_{i,j}^{l} that all forces between two objects are equal in magnitude and opposite in direction as stipulated in the law of momentum conservation.

The law of momentum conservation is the most basic law in dynamics systems, which is a direct corollary of Newton's laws of motion. However, many previously developed machine learning-based physical system simulators ignore this law and do not explicitly introduce this law as a constraint on neural networks. In conventional MPNN solutions, m_{j, i}^{l} is calculated similarly to m_{i,j}^{l}=f_{e, l}^{(ξ, η)}(hᵢ^{ξ, l-1}, hⱼ^{η, l-1}, h_{i,j}^{l-1}). These conventional solutions rely on the recognition that the neural network 105 is naturally capable of learning a message feature representation that satisfies the law of momentum conservation from a sufficiently large amount of training data.

However, the inventors of the present application have found through research and experiments that by introducing the calculation of m_{j, i}^{l}=m_{i,j}^{l}, this simple adjustment not only ensures the conservation of momentum, but also reduces the calculation amount of message feature representations in the neural network by half without changing the quantity of network parameters, while the calculation of message feature representations accounts for the vast majority of the calculation amount of the entire network in the MPNN architecture. In addition, due to the introduction of the momentum conservation constraint, the training of the neural network 105 can converge faster, and the neural network 105 can be trained to have better stability.

In some embodiments of the present disclosure, special processing of boundary physical units in the physical system is further proposed. When simulating the dynamics of real physical systems, tricky boundary conditions are often encountered. For example, the deformation of an elastomer after encountering an irregular boundary is an important issue in FEM analysis. In some embodiments of the present disclosure, physical units at the system boundary in the physical system are identified as boundary physical units, and these boundary physical units are also characterized by boundary nodes in the directed graph. Such boundary nodes can model the edges of the physical system.

When the neural network 105 predicts the dynamics state of the physical system, the boundary nodes (i.e., boundary physical units) can be regarded as stationary nodes. Thus, the collision process between the material and the boundary can be modeled by the message passing between the node corresponding to the material physical unit and the boundary node. In this way, the neural network 105 can be trained under simple boundary conditions and generalized to very complex boundary conditions.

In the stage of network application, for example, one or more boundary physical units in the target physical system may be identified for the target physical system. When performing the state prediction, the neural network 105 may not have to dynamically determine the location of the boundary physical unit, but consider by default that the location of the boundary physical unit remains unchanged.

In some embodiments, by selecting appropriate graph topology structures to characterize various types of physical systems, the state prediction architecture based on the graph neural network proposed herein can be uniformly and flexibly applied to various types of physical systems.

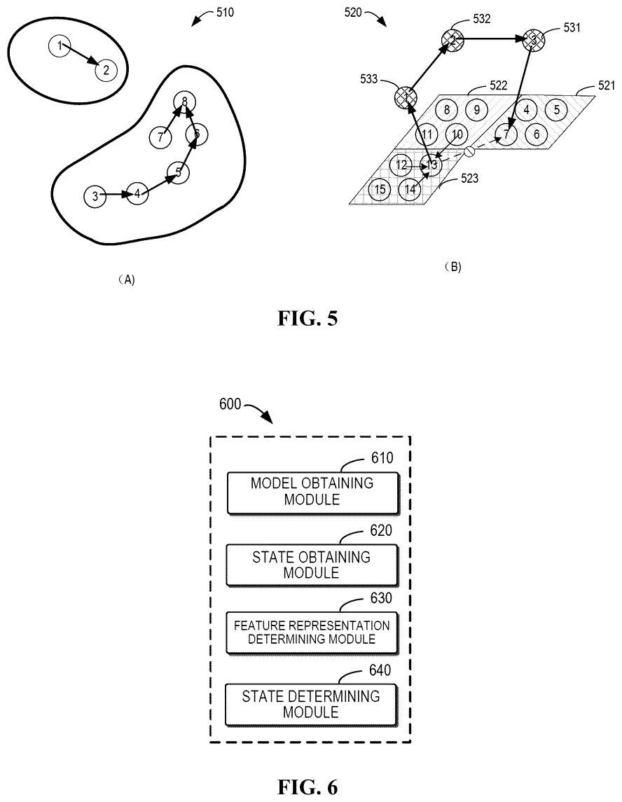

In some embodiments, if the physical system to be simulated is a particle-based discretized physical system for training, this type of physical system can be characterized using data based on dynamics nearest-neighbor graphs. FIG. 5 illustrates an example directed graph for modeling a physical system according to some embodiments of the present disclosure. In FIG. 5, a directed graph 510 utilizes a dynamics nearest-neighbor graph to characterize the physical system.

Particle-based discretized systems include amorphous bodies composed of materials that do not have a fixed shape, such as liquids, sand, snow, etc. For particle-based discretized systems, they are modeled by a dynamics nearest-neighbor graph, such that if the distance between two particles is less than a threshold r, then the two particles are connected based on the dynamics nearest-neighbor graph. The graph topology of the dynamics nearest-neighbor graph can reflect the fact that the interaction strength between two particles disappears as their distance increases. Due to the deformation of the physical system during the simulation process, the nearest-neighbor graph needs to be updated at each time point to reflect the deformation state of the physical system.

In some embodiments, if the physical system to be simulated is a grid-based discretized physical system, this type of physical system is characterized using a static multi-scale raster graph. Static multi-scale raster graphs can include graph topology across multiple points in time. A directed graph 520 in FIG. 5 utilizes a static multi-scale raster graph to characterize the physical system.

In a static multi-scale raster graph, one node is set for each grid point, and only nodes in the same grid cell are connected by edges to reflect the structure of the grid. In order to consider the integrity and long-range interactions during solid deformation, multi-scale grid graph topology can be exploited. Taking a two-dimensional structure as an example, several grids (for example, four grids) in the same grid unit can be merged into a “macro grid”, such as macro grids 521, 522, and 523 shown in FIG. 5. However, a new “virtual node” can be used to represent the macro grid, and the connectivity between virtual nodes can be refined into “virtual edges” in the graph. For example, in FIG. 5, a virtual node 531 represents the macro grid 521, a virtual node 532 represents the macro grid 522, and a virtual node 533 represents the macro grid 523. In addition, multiple adjacent macro grids can be further merged into a larger macro grid until the entire system is merged into the largest macro grid. These virtual nodes and virtual edges are only used to describe the macro structure and establish high-speed paths for force transfer, rather than representing real physical units or the movement of physical units in the physical system. In this way, shaped bodies (e.g., elastomers, and other materials that can be deformed but retain their overall shape) can be well described.

For a physical system characterized by a dynamics nearest-neighbor graph or a static multi-scale raster graph, the dynamical simulation may be implemented using the architecture of the neural network 105 described above, to determine the state changes of the physical system over time.

FIG. 6 illustrates a block diagram of an apparatus 600 for state prediction of a state system according to some embodiments of the present disclosure. The apparatus 600 may be implemented as or included in the network application system 120. Each module/component in the apparatus 600 may be implemented in hardware, software, firmware, or any combination thereof.

As illustrated, the apparatus 600 includes a network obtaining unit 610 configured to obtain a neural network, the neural network being trained to determine a state change of a physical system over time, training data of the neural network indicating states of a plurality of physical systems at a plurality of times. The apparatus 600 further includes a state obtaining unit 620 configured to obtain state data corresponding to a state of a target physical system at a first time, the state data indicating a plurality of physical units comprised in the target physical system, material properties of the plurality of physical units, and interaction relationships between the plurality of physical units. The apparatus 600 further includes a feature representation determining unit 630 configured to determine respective unit feature representations of the plurality of physical units in the target physical system based at least on target values of respective material properties of the plurality of physical units. The apparatus 600 further includes a state determining unit 640 configured to determine a state of the target physical system at a second time based on the state data by inputting at least the unit feature representations to the neural network.

In some embodiments, the feature representation determining unit 630 is configured to, for a given physical unit among the plurality of physical units, determine a plurality of values of a physical unit having a same material property as the physical unit in the plurality of physical systems; and in response to the target value of the material property of the given physical unit falling between a first value and a second value of the plurality of values, determine a unit feature representation of the given physical unit based at least on a first feature representation corresponding to the first value of the material property and a second feature representation corresponding to the second value of the material property.

In some embodiments, the feature representation determining unit 630 is configured to determine a first interpolation weight for the first value and a second interpolation weight for the second value based on a difference between the target value and the first value and a difference between the target value and the second value; and perform interpolation of the first feature representation with the first interpolation weight and the second feature representation with the second interpolation weight.

In some embodiments, the feature representation determining unit 630 is further configured to determine the respective unit feature representations of the plurality of physical units based at least on one of the following: respective velocities of the plurality of physical units at the first time, and an external force applied to the plurality of physical units respectively at the first time.

In some embodiments, the apparatus 600 further includes: a relationship feature representation determining unit configured to determine respective relationship feature representations of the interaction relationships between the plurality of physical units, each relationship feature representation being determined based at least on relative locations of a pair of physical units having an interaction relationship at the first time.

In some embodiments, the state determining unit 640 is configured to determine, by the neural network, a first message feature representation from a first physical unit to a second physical unit among the plurality of physical units, the first message feature representation characterizing an effect of the first physical unit on the second physical unit; determine a negative value of the first message feature representation as a second message feature representation from the second physical unit to the first physical unit, the first message feature representation characterizing an effect of the second physical unit on the first physical unit; and determine, by the neural network, the state of the target physical system at the second time based at least on the first message feature representation and the second message feature representation.

In some embodiments, the state determining unit 640 is configured to determine respective locations of the plurality of physical units in the target physical system at the second time.

In some embodiments, the plurality of physical units comprise at least one boundary physical unit at a boundary of the physical system, wherein a location of the at least one boundary physical unit remains unchanged when determining the locations of the plurality of physical units at the second time.

In some embodiments, the state data comprises graph data with a plurality of nodes and a plurality of directed edges between the plurality of nodes, the plurality of nodes characterizing the plurality of physical units in the target physical system respectively, and the plurality of edges characterizing the interaction relationships between the plurality of physical units respectively.

In some embodiments, the neural network is trained for a particle-based discretized physical system, and the graph data comprises data based on a dynamics nearest neighbor graph. In some embodiments, the neural network is trained for a grid-based discretized physical system, and the graph data comprises data based on a static multi-scale grid graph.

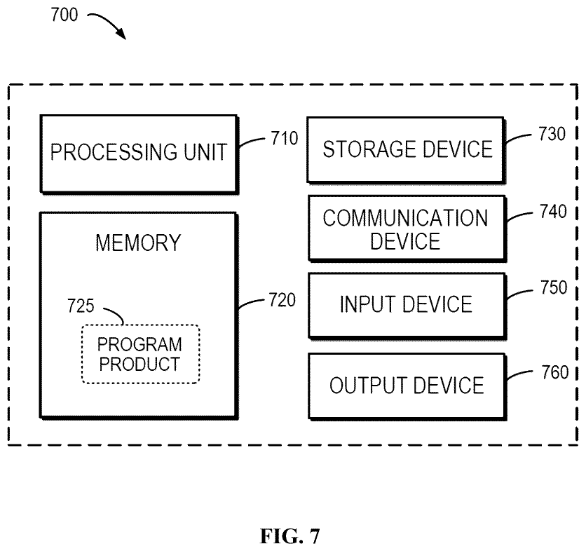

FIG. 7 illustrates a block diagram of a computing device 700 in which one or more embodiments of the present disclosure may be implemented. It would be appreciated that the computing device 700 shown in FIG. 7 is only an example and should not be configured as implying any limitation on the functionality and scope of the embodiments described herein. The computing device 700 shown in FIG. 7 may be used to implement the network training system 110 and/or the network application system 120 of FIG. 1.

As shown in FIG. 7, the computing device 700 is in the form of a general computing device. The components of the computing device 700 may include, but are not limited to, one or more processors or processing units 710, a memory 720, a storage device 730, one or more communication units 740, one or more input devices 750, and one or more output devices 760. The processing unit 710 may be an actual or virtual processor and can execute various processes according to the programs stored in the memory 720. In a multiprocessor system, multiple processing units execute computer executable instructions in parallel to improve the parallel processing capability of the computing device 700.

The computing device 700 typically includes a variety of computer storage medium. Such medium may be any available medium that is accessible to the computing device 700, including but not limited to volatile and non-volatile medium, removable and non-removable medium. The memory 720 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 730 may be any removable or non-removable medium, and may include a machine-readable medium, such as a flash drive, a disk, or any other medium, which can be used to store information and/or data (such as training data for training) and can be accessed within the computing device 700.

The computing device 700 may further include additional removable/non-removable, volatile/non-volatile storage medium. Although not shown in FIG. 7, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 720 may include a computer program product 725, which has one or more program modules configured to perform various methods or acts of various embodiments of the present disclosure.

The communication unit 740 communicates with a further computing device through the communication medium. In addition, functions of components in the computing device 700 may be implemented by a single computing cluster or multiple computing machines, which can communicate through a communication connection.

Therefore, the computing device 700 may be operated in a networking environment using a logical connection with one or more other servers, a network personal computer (PC), or another network node.

The input device 750 may be one or more input devices, such as a mouse, a keyboard, a trackball, etc. The output device 760 may be one or more output devices, such as a display, a speaker, a printer, etc. The computing device 700 may also communicate with one or more external devices (not shown) through the communication unit 740 as required. The external device, such as a storage device, a display device, etc., communicate with one or more devices that enable users to interact with the computing device 700, or communicate with any device (for example, a network card, a modem, etc.) that makes the computing device 700 communicate with one or more other computing devices. Such communication may be executed via an input/output (I/O) interface (not shown).

According to example implementation of the present disclosure, a computer-readable storage medium is provided, on which a computer-executable instruction or computer program is stored, wherein the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is exemplary, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

1. A method for state prediction, comprising:
obtaining a neural network, the neural network being trained to determine a state change of a physical system over time, training data of the neural network indicating states of a plurality of physical systems at a plurality of times;
obtaining state data corresponding to a state of a target physical system at a first time, the state data indicating a plurality of physical units comprised in the target physical system, material properties of the plurality of physical units, and interaction relationships between the plurality of physical units;
determining respective unit feature representations of the plurality of physical units in the target physical system based at least on target values of respective material properties of the plurality of physical units; and
determining a state of the target physical system at a second time based on the state data by inputting at least the unit feature representations to the neural network.

2. The method of claim 1, wherein determining the respective unit feature representations of the plurality of physical units comprises: for a given physical unit among the plurality of physical units,
determining a plurality of values of a physical unit having a same material property as the physical unit in the plurality of physical systems; and
in response to the target value of the material property of the given physical unit falling between a first value and a second value of the plurality of values, determining a unit feature representation of the given physical unit based at least on a first feature representation corresponding to the first value of the material property and a second feature representation corresponding to the second value of the material property.

3. The method of claim 2, wherein determining the unit feature representation of the given physical unit comprises:
determining a first interpolation weight for the first value and a second interpolation weight for the second value based on a difference between the target value and the first value and a difference between the target value and the second value; and
performing interpolation of the first feature representation with the first interpolation weight and the second feature representation with the second interpolation weight.

4. The method of claim 1, wherein determining the respective unit feature representations of the plurality of physical units further comprises:
determining the respective unit feature representations of the plurality of physical units based at least on one of the following: respective velocities of the plurality of physical units at the first time, and an external force applied to the plurality of physical units respectively at the first time.

5. The method of claim 1, wherein the determining a state of the target physical system at a second time based on the state data by inputting at least the unit feature representations to the neural network comprise:
determining respective relationship feature representations of the interaction relationships between the plurality of physical units, each relationship feature representation being determined based at least on relative locations of a pair of physical units having an interaction relationship at the first time; and
determining a state of the target physical system at a second time based on the state data by inputting the unit feature representations and the respective relationship feature representations to the neural network.

6. The method of claim 1, wherein determining the state of the target physical system at the second time comprises:
determining, by the neural network, a first message feature representation from a first physical unit to a second physical unit among the plurality of physical units, the first message feature representation characterizing an effect of the first physical unit on the second physical unit;
determining a negative value of the first message feature representation as a second message feature representation from the second physical unit to the first physical unit, the first message feature representation characterizing an effect of the second physical unit on the first physical unit; and
determining, by the neural network, the state of the target physical system at the second time based at least on the first message feature representation and the second message feature representation.

7. The method of claim 1, wherein determining the state of the target physical system at the second time comprises:
determining respective locations of the plurality of physical units in the target physical system at the second time.

8. The method of claim 7, wherein the plurality of physical units comprise at least one boundary physical unit at a boundary of the physical system, wherein a location of the at least one boundary physical unit remains unchanged when determining the locations of the plurality of physical units at the second time.

9. The method of claim 1, wherein the state data comprises graph data with a plurality of nodes and a plurality of directed edges between the plurality of nodes, the plurality of nodes characterizing the plurality of physical units in the target physical system respectively, and the plurality of edges characterizing the interaction relationships between the plurality of physical units respectively.

10. The method of claim 9, wherein the neural network is trained for a particle-based discretized physical system, and the graph data comprises data based on a dynamics nearest neighbor graph, and
wherein the neural network is trained for a grid-based discretized physical system, and the graph data comprises data based on a static multi-scale grid graph.

11. An electronic device, comprising:
at least one processing unit; and
at least one memory coupled to the at least one processing unit and storing instructions for execution by the at least one processing unit, the instructions, when executed by the at least one processing unit, causing the device to perform the following actions:
obtaining a neural network, the neural network being trained to determine a state change of a physical system over time, training data of the neural network indicating states of a plurality of physical systems at a plurality of times;
obtaining state data corresponding to a state of a target physical system at a first time, the state data indicating a plurality of physical units comprised in the target physical system, material properties of the plurality of physical units, and interaction relationships between the plurality of physical units;
determining respective unit feature representations of the plurality of physical units in the target physical system based at least on target values of respective material properties of the plurality of physical units; and
determining a state of the target physical system at a second time based on the state data by inputting at least the unit feature representations to the neural network.

12. The device of claim 11, wherein determining the respective unit feature representations of the plurality of physical units comprises: for a given physical unit among the plurality of physical units,
determining a plurality of values of a physical unit having the same material property as the physical unit in the plurality of physical systems; and
in response to the target value of the material property of the given physical unit falling between a first value and a second value of the plurality of values, determining a unit feature representation of the given physical unit based at least on a first feature representation corresponding to the first value of the material property and a second feature representation corresponding to the second value of the material property.

13. The device of claim 12, wherein determining the unit feature representation of the given physical unit comprises:
determining a first interpolation weight for the first value and a second interpolation weight for the second value based on a difference between the target value and the first value and a difference between the target value and the second value; and
performing interpolation of the first feature representation with the first interpolation weight and the second feature representation with the second interpolation weight.

14. The device of claim 11, wherein determining the respective unit feature representations of the plurality of physical units further comprises:
determining the respective unit feature representations of the plurality of physical units based at least on one of: respective velocities the plurality of physical units at the first time, and an external force applied to the plurality of physical units respectively at the first time.

15. The device of claim 11, wherein the determining a state of the target physical system at a second time based on the state data by inputting at least the unit feature representations to the neural network comprises:
determining respective relationship feature representations of the interaction relationships between the plurality of physical units, each relationship feature representation being determined based at least on relative locations of a pair of physical units having an interaction relationship at the first time; and
determining a state of the target physical system at a second time based on the state data by inputting the unit feature representations and the respective relationship feature representations to the neural network.

16. The device of claim 11, wherein determining the state of the target physical system at the second time comprises:
determining, by the neural network, a first message feature representation from a first physical unit to a second physical unit among the plurality of physical units, the first message feature representation characterizing an effect of the first physical unit on the second physical unit;
determining a negative value of the first message feature representation as a second message feature representation from the second physical unit to the first physical unit, the first message feature representation characterizing an effect of the second physical unit on the first physical unit; and
determining, by the neural network, the state of the target physical system at the second time based at least on the first message feature representation and the second message feature representation.

17. The device of claim 11, wherein determining the state of the target physical system at the second time comprises:
determining respective locations of the plurality of physical units in the target physical system at the second time.

18. The device of claim 17, wherein the plurality of physical units comprise at least one boundary physical unit at a boundary of the physical system, wherein a location of the at least one boundary physical unit remains unchanged when determining the locations of the plurality of physical units at the second time.

19. The device of claim 11, wherein the state data comprises graph data with a plurality of nodes and a plurality of directed edges between the plurality of nodes, the plurality of nodes characterizing the plurality of physical units in the target physical system respectively, and the plurality of edges characterizing the interaction relationships between the plurality of physical units respectively.

20. (canceled)

21. (canceled)

22. A non-transitory computer-readable storage medium having a computer program stored thereon, the computer program, when executed by a processing unit, causing the processing unit to perform the following actions:
obtaining a neural network, the neural network being trained to determine a state change of a physical system over time, training data of the neural network indicating states of a plurality of physical systems at a plurality of times;
obtaining state data corresponding to a state of a target physical system at a first time, the state data indicating a plurality of physical units comprised in the target physical system, material properties of the plurality of physical units, and interaction relationships between the plurality of physical units;
determining respective unit feature representations of the plurality of physical units in the target physical system based at least on target values of respective material properties of the plurality of physical units; and
determining a state of the target physical system at a second time based on the state data by inputting at least the unit feature representations to the neral network.

23. (canceled)
